(19) United States
(12) Patent Application Publication
(10) Pub. No.: US 2007/0237975 A1
(43) Pub. Date: Oct. 11, 2007

(54) Unit Block Used in Manufacturing Core with Soft Magnetic Metal Powder, and Method for Manufacturing Core with High Current Dc Bias Characteristics Using the Unit Block

(76) Inventors: Jae-Yeol Park, Incheon (KR); Bong-Gi You, Incheon (KR); Tae-Kyung Lee, Incheon (KR)

Correspondence Address: Blakely, Sokoloff, Taylor & Zafman, 12400 Wilshire Boulevard, 7th Floor, Los Angeles, CA, 90025, US

(21) Appl. No.: 10/576,850

(22) PCT Filed: Oct. 22, 2004
(86) PCT No.: PCT/KR04/02700

§ 371 Date: Feb. 26, 2007

(30) Foreign Application Priority Data
Oct. 24, 2003 (KR) 10-2003-0074561

(51) Int. Cl. H01F 3/04

(52) U.S. Cl. 428/546; 156/272.2

(57) ABSTRACT

A unit block for a core using soft magnetic metal powder, a core having excellent high-current DC bias characteristics using the unit block, and a method of producing the core are disclosed. The unit block is used to produce cores applied to an active filter for PFC, a three-phase line reactor, or an inductor for automotive electronics. A method of producing the core comprises mixing sendust alloy, High Flux, MPP, or silicon steel powders, which have an average particle size of 175 gm or less, with a solid lubricant; compacting a mixture at a pressure of 10-18 tons per unit area; heat-treating the compacted mixture at 600-800° C. for 1-2 hours to form the unit blocks each having a length of 3-10 cm, a width of 1-5 cm, and a height of 1-5 cm; and attaching the unit blocks using a heat- and fire-resistant adhesive.

### TECHNICAL FIELD

The present invention relates to a unit block for a core using soft magnetic metal powder, a core having excellent high-current DC bias characteristics using the unit block, and a method of producing the core. More particularly, the present invention pertains to a unit block for a core using soft magnetic metal powder, a core having excellent high-current DC bias characteristics using the unit block, and a method of producing the core, in which the unit block is used to produce the core applied to an active filter (a high-current step-down inductor or a high-current step-up inductor) for PFC (power factor correction), a three-phase line reactor, or an inductor for automotive electronics employing a fuel cell system.

### BACKGROUND ART

Applied to a conventional active filter (a high-current step-down inductor or a high-current step-up inductor) for PFC (power factor correction), a three-phase line reactor, or an inductor for automotive electronics employing a fuel cell system, a soft magnetic core is made of pure iron, silicon steel, amorphous materials or the like, and classified into a laminated core and EE and EI type cores.

The laminated silicon steel core or amorphous core is applied to an active filter (the high-current step-down inductor or the high-current step-up inductor) for PFC (power factor correction) having a switching frequency of 50 kHz or less, or to a three-phase line reactor so as to suppress electron noise using the bias of a high frequency current. However, the laminated silicon steel core or amorphous core is disadvantageous in that the occurrence of heat and noise is undesirably significant due to a high core loss and a high magnetostriction constant. A dimension must be large in order to overcome this disadvantage, resulting in economic inefficiency.

Additionally, since the soft magnetic toroidal core, which is produced for the above applications, cannot have an external diameter that is more than 77-100 mm because of a limit of a pressing ability of a high pressure press, it is impossible to apply the soft magnetic toroidal core to larger products.

Furthermore, even though a core made of pure iron powder has the advantage of a low price, it is disadvantageous in that since a core loss is very significant, overheating occurs and magnetic permeability is significantly reduced when a high DC current is biased. As well, the laminated silicon steel core or amorphous core is applied to an active filter (the high-current step-down inductor or the high-current step-up inductor) for PFC (power factor correction) having a switching frequency of 50 kHz or less, or to a three-phase line reactor so as to suppress electron noise using the bias of the high frequency current. However, the laminate-type silicon steel plate core or amorphous core is disadvantageous in that the occurrence of heat and noise is undesirably significant due to the high core loss and magnetostriction constant.

On the other hand, MPP core has advantages in that it has excellent frequency characteristics within a frequency range of 1-100 kHz, core loss is lowest among metal powder cores, and reduction of magnetic permeability is small when the high DC current is biased. However, it has the disadvantage of a high price. A High Flux core has advantages in that it has excellent frequency characteristics within a frequency range of 1-100 kHz, core loss is low, and reduction of magnetic permeability is smallest among the metal powder cores when the high DC current is biased.

Additionally, sendust core has advantages in that core loss is a lot lower than when using pure iron, frequency characteristics are almost the same as those of the MPP core or High Flux core, and the price is about half that of the MPP core or High Flux core. However, high-current DC bias characteristics are somewhat lower than the MPP core or High Flux core. Furthermore, even though silicon steel powder, which consists of 5-8 wt % of Si and Fe as a balance, has a core loss that is higher than the MPP, High Flux, and sendust cores, it is advantageous in that high-current DC bias characteristics are better than the MPP core or sendust core and the price is low.

### BRIEF DESCRIPTION OF DRAWINGS

FIG. 1 schematically illustrates a unit block for a core using soft magnetic metal powder, according to the present invention;

FIG. 2 schematically illustrates a single-phase reactor which is produced employing unit blocks for a core using the soft magnetic metal powder, according to the present invention;

FIG. 3 schematically illustrates a three-phase reactor which is produced employing unit blocks for a core using the soft magnetic metal powder, according to the present invention;

FIG. 4 is a graph which comparatively shows DC bias characteristics of a single-phase reactor, produced using silicon steel powder, according to the present invention, and of a conventional toroidal core; and

FIG. 5 is a graph which comparatively shows DC bias characteristics of the three-phase reactor, produced using the soft magnetic metal powder, according to the present invention, and of a conventional three-phase reactor including a laminated silicon steel.

### DISCLOSURE OF THE INVENTION

Technical Tasks to be Solved by the Invention

Accordingly, the present invention has been made keeping in mind the above problems of pure iron powder, a laminated silicon steel, or an amorphous core used in the prior arts, and an object of the present invention is to provide a block for a core using soft magnetic metal powder, a core having excellent high current DC bias characteristics using the block, and a method of producing the core. In this regard, MPP, High Flux, sendust, or silicon steel powder is selectively employed, depending on the purpose, the size of an inductor and the price, to produce a block. Accordingly, the block can be applied to an active filter (a high current step-down inductor or a high current step-up inductor) for PFC (power factor correction), a three-phase line reactor, or an inductor for automotive electronics employing a fuel cell system.

Technical Solution

In order to accomplish the above object, the present invention provides a unit block for a core employing soft magnetic metal powder, which comprises one or more powders which each have an average particle size of 175 μm or less and which are selected from the group consisting of sendust powder, High Flux powder, MPP powder, and silicon steel powder. The powders are compacted and heat treated to form the unit block having a length of 3-10 cm, a width of 1-5 cm, and a height of 1-5 cm.

Furthermore, the present invention provides the unit block which is characterized in that the sendust powder contains 9-10% Si, 4-8% Al, and the balance of Fe, the High Flux powder contains 45-55% Ni and the balance of Fe, the MPP powder contains 80-81% Ni, 16-18% Fe, and 1.5-2.5% Mo, and the silicon steel powder contains 5-8 wt % Si and the balance of Fe.

Additionally, the present invention provides a core, which employs unit blocks made of soft magnetic metal powders and which has excellent high current DC bias characteristics. The core comprises the unit blocks for the core, which are produced using one or more selected from the group consisting of sendust powder, High Flux powder, MPP powder, and silicon steel powder, and which each have a length of 3-10 cm, a width of 1-5 cm, and a height of 1-5 cm. The unit blocks are attached to each other using a heat and fire resistant epoxy or polyurethane adhesive to form a single-phase reactor or a three-phase reactor.

As well, the present invention provides a method of producing a core, which employs unit blocks made of soft magnetic metal powders and which has excellent high current DC bias characteristics. The method comprises mixing one or more, each having an average particle size of 175 μm or less, selected from the group consisting of sendust powder, High Flux powder, MPP powder, and silicon steel powder, with a solid lubricant; compacting a powder mixture at a pressure of 10-18 tons per unit area so that each of the unit blocks is 3-10 cm long, 1-5 cm wide, and 1-5 cm high; heat-treating the compacted mixture at 600-800° C. for 1-2 hours in an inert gas atmosphere to form the unit blocks each having a length of 3-10 cm, a width of 1-5 cm, and a height of 1-5 cm; and attaching the unit blocks to each other using a heat and fire resistant epoxy or polyurethane adhesive to form the core.

Hereinafter, a detailed description will be given of the present invention, with reference to the drawings.

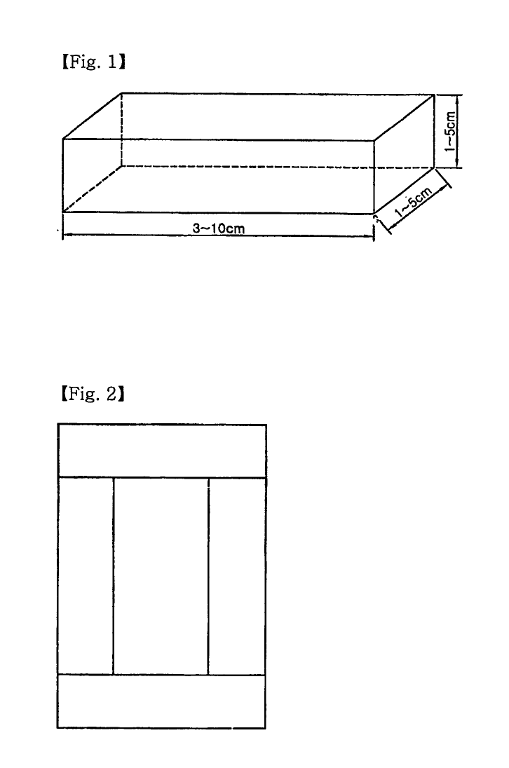

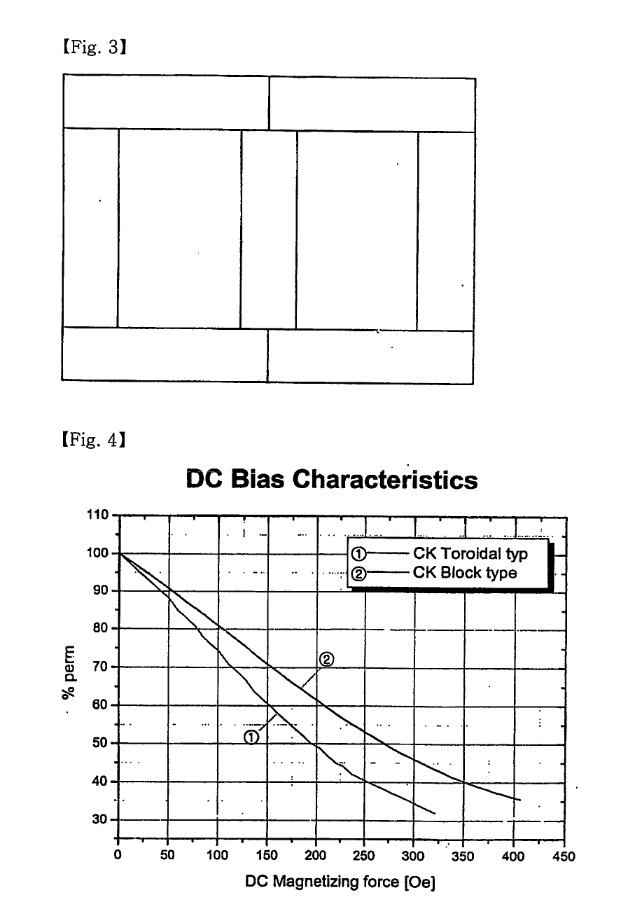

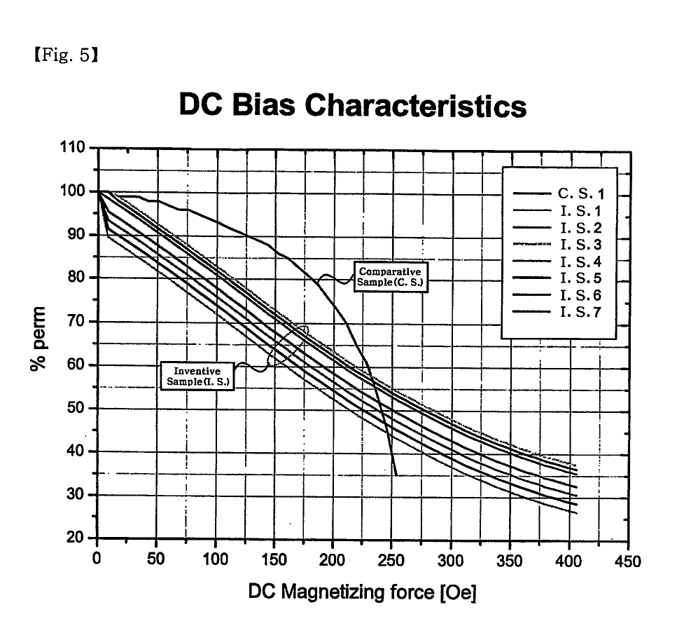

FIG. 1 schematically illustrates a soft magnetic block core according to the present invention, FIG. 2 schematically illustrates a single-phase reactor produced employing the soft magnetic block core according to the present invention, and FIG. 3 schematically illustrates a three-phase reactor produced employing the soft magnetic block core according to the present invention.

The reasons for numerical limitations in the specification of the present invention will be given, below.

Produced employing the soft magnetic metal powder according to the present invention, a unit block is of a hexahedral shape and 3-10 cm long, 1-5 cm wide, and 1-5 cm high.

The reason why the length, width, and height of the unit block are limited is as follows. When the length is 3 cm or less, the width is 1 cm or less, and the height is 1 cm or less, the time and expense required to assemble unit blocks increases. When the length is 10 cm or more, the width is 5 cm or more, and the height is 5 cm or more, it is impossible in practice to install a press required to produce the unit block.

Additionally, an average particle size of the soft magnetic metal powder used in the present invention is set to 175 μm or less so as to assure excellent compacting strength of the unit block and to prevent the press from being damaged.

Furthermore, the unit block of the present invention is formed at a compacting pressure of 10-18 tons per unit area (cm²). When the compacting pressure is 10 tons or less, it is difficult to maintain the shape of the unit block. Additionally, it is difficult to provide a device withstanding a compacting pressure of 18 tons or more.

Meanwhile, the unit block formed under the above conditions is heat treated at 600-800° C. for 1-2 hours in an inert gas atmosphere to complete the production of the unit block. The above temperature and time are limited in order to desirably remove the residual stress of the unit block in the course of forming the unit block in a non-oxidizing atmosphere.

As well, in the present invention, the unit blocks are adhered to each other using a heat and fire resistant adhesive to form a core. An epoxy or polyurethane adhesive is used as the heat and fire resistant adhesive.

The reason why the epoxy or polyurethane adhesive is used as the heat and fire resistant adhesive is that the epoxy or polyurethane adhesive does not lose adhesion strength at a high temperature of 100° C. or more, at which the core is used in practice.

Hereinafter, a description will be given of the preparation of the soft magnetic metal powder according to the present invention.

Sendust powder used in the present invention is prepared according to the same procedure as Korean Pat. Application No. 1998-62927, which has been made by the applicant of the present invention, and the preparation of the powder will be briefly described, below.

A sendust ingot, which has high magnetic permeability and low loss properties and which consists of 9.6% Si, 5.4% Al, and the balance of Fe, is crushed using a jaw crusher, a rotary crusher, a hammer mill or the like, treated using a ball mill for 1 hour, and heat treated at 800-900° C. for 8 hours in a mixed gas atmosphere of hydrogen and nitrogen. The heat-treated powder is subjected to a wet-insulation coating process employing 1.0-2.0 wt % of insulation ceramic, or a dry-insulation coating process employing a low melting point ceramic binder to produce sendust powder.

The preparation of High Flux or MPP powder consisting of Ni and Fe, or consisting of Ni, Fe and Mo is disclosed in Korean Pat. Application No. 2001-61455 and 1997-9412, which have been made by the applicant of the present invention, and will be briefly described below.

The High Flux or MPP powder is produced using a spray process, heat treated at 800-900° C. for 8 hours in a mixed gas atmosphere of hydrogen and nitrogen. The heat-treated powder is subjected to an insulation coating process employing 0.5-3.0 wt % of mixed ceramic. The mixed ceramic contains magnesium hydroxide, kaoline, talc, and water glass (sodium silicate) mixed with each other.

As for silicon steel powder having excellent DC bias characteristics, as disclosed in Korean Pat. Application No. 2000-4180 which has been made by the applicant of the present invention, Fe and Si are melted so that a molten mixture contains 6.5% Si and the balance of Fe, and sprayed using a mixed gas, which includes one or more gases selected from the group consisting of N₂, He, Ne, Ar, Xe, and Rn gases, to produce powder. The powder is heat treated at 800-900° C. for 8 hours in an atmosphere of hydrogen, nitrogen, or a mixed gas of hydrogen and nitrogen. Subsequently, powder having a particle size of 80 mesh (175 μm) or less is selected, and then subjected to a wet-insulation coating process employing 0.5-2.0 wt % of mixed ceramic, or subjected to a dry-insulation coating process employing a glass frit to create the silicon steel powder for the block.

Additionally, if necessary, composite powder may be prepared through a process disclosed in Korean Pat. Application No. 2000-46247, which has been made by the applicant of the present invention.

Subsequently, the prepared powder (the MPP, High Flux, sendust, or composite powder) is mixed with a solid lubricant, such as Zn, ZnS, or stearic acid, in a predetermined amount to be compacted into a block-type core.

The compaction is conducted in a die using a power press, and the lubricant is used to reduce frictional forces between the die and the compact, and between powder particles.

At this stage, a unit block having a length of 6 cm, a width of 3 cm, and a height of 2 cm is compacted at a high compacting pressure of 100-500 tons (10-18 tons per unit area [cm²]).

Next, the compacted unit core is heat treated at 650-750° C. for 1 hour in a nitrogen atmosphere so as to remove residual stress and strain, thereby completing the production of the unit block for the core.

The dimensions and shape of the unit block produced through the above procedure are designed depending on the dimensions and purpose of the core. The unit blocks are assembled with each other using an adhesive having excellent heat and fire resistance, and then installed on an external side of a bracket, thereby creating the core which is useful in a surface mounting process and which can withstand vibration and impact.

Advantageous Effects

As descried above, a soft magnetic core produced using a soft magnetic unit block made of metal powder according to the present invention is advantageous in that the low-priced metal powder, such as silicon steel (Fe—Si) alloy powder, sendust, MPP, and High Flux, is used to assure excellent high current DC bias characteristics and low core loss. Thereby, it is possible to produce the soft magnetic block core made of the metal powder, which can reduce the occurrence of heat and noise and reduce the dimension and weight of an inductor due to increased magnetic permeability and low noise. That soft magnetic block core may be used instead of a conventional soft magnetic core applied to an active filter (a high current step-down inductor or a high current step-up inductor) for PFC (power factor correction), a three-phase line reactor, or an inductor for automotive electronics employing a fuel cell system.

Additionally, the core of the present invention can be diversely shaped according to its dimension and purpose.

### BEST MODE FOR CARRYING OUT THE INVENTION

### EXAMPLE 1

A sendust ingot, which had high magnetic permeability and low loss characteristics and which consisted of 9.6 wt % Si, 5.4 wt % Al, and the balance of Fe, was crushed to produce sendust powder having a size of 300 mesh (50 μm) or less. The sendust powder was subjected to a wet-insulation coating process employing 1.0 wt % of mixed ceramic or a dry-insulation coating process employing a glass frit, thereby completing the preparation of the sendust powder (Korean Pat. Application No. 1998-62927).

After a lubricant was added to the coated sendust powder, the resulting powder was compacted at a high compacting pressure of 100-500 tons into a unit block having a length of 60 mm, a width of 30 mm, and a height of 20 mm, and then heat treated at 700-800° C. for 1 hour in a nitrogen atmosphere to complete the production of the unit block for a core.

### EXAMPLE 2

Powder (MPP) having a size of 300 mesh (50 μm) or less, which was prepared using a spray process and which consisted of 2% of Mo, 80% of Ni, and Fe as a balance, was subjected to a wet-insulation coating process employing 1.0 wt % of mixed ceramic, thereby completing the preparation of the MPP powder (Korean Pat. Application No. 1997-0009412).

After stearic acid was added as a lubricant to the coated MPP powder, the resulting powder was compacted at a high compacting pressure of 100-500 tons into a block core having a length of 60 mm, a width of 30 mm, and a height of 20 mm, and then heat treated at 700-800° C. for 1 hour in a nitrogen -atmosphere to complete the production of the core for the core.

### EXAMPLE 3

High Flux powder having a size of 300 mesh (50 μm) or less, which was produced using a spray process and which consisted of 50% Ni and the balance of Fe, was subjected to an insulation coating process employing 1.0 wt % of mixed ceramic, thereby completing the preparation of the High Flux powder (Korean Pat. Application No. 2001-61455).

After a lubricant was added to the coated High Flux powder, the resulting powder was compacted at a high compacting pressure of 100-500 tons into a block core having a length of 60 mm, a width of 30 mm, and a height of 20 mm, and then heat treated at 700-800° C. for 1 hour in a nitrogen atmosphere to complete the production of the unit block for the core.

### EXAMPLE 4

Fe and Si were melted so that a molten mixture contained 6.5% Si and the balance of Fe, and sprayed using a mixed gas, which included one or more gases selected from the group consisting of N₂, He, Ne, Ar, Xe, and Rn gases, to produce powder. The powder was heat treated at 880° C. for 8 hours in an atmosphere of hydrogen, nitrogen, or a mixed gas of hydrogen and nitrogen. Subsequently, powder having a particle size of 80 mesh (175 μm) or less was selected, and then subjected to a wet-insulation coating process employing 0.5-2.0 wt % of mixed ceramic, or subjected to a dry-insulation coating process employing a low melting point ceramic binder to create silicon steel powder (Korean Pat. Application No. 2000-4180).

After a lubricant was added to the coated silicon steel powder, the resulting powder was compacted at a high compacting pressure of 100-500 tons into a block core having a length of 60 mm, a width of 30 mm, and a height of 20 mm, and then heat treated at 700-800° C. for 1 hour in a nitrogen atmosphere to complete the production of the unit block for the core.

### EXAMPLE 5

The powders prepared through examples 1 to 4 were mixed with each other in such a way that the silicon steel powder was used as a main component according to the purpose, thereby preparing composite powder (Korean Pat. Application No. 20004180).

After a lubricant was added to the composite powder, the resulting powder was compacted at a high compacting pressure of 100-500 tons into a block core having a length of 60 mm, a width of 30 mm, and a height of 20 mm, and then heat treated at 700-800° C. for 1 hour in a nitrogen atmosphere to complete the production of the unit block for the core.

### EXAMPLE 6

The soft magnetic metal powder blocks prepared through examples 1 to 4 were shaped according to their application, and an adhesive having excellent heat and fire resistance was applied to surfaces of the blocks to attach the blocks to each other. Next, a bracket was provided on a surface of a core, which was composed of the blocks adhered to each other, so as to endure impact and vibration, and the resulting structure was then subjected to a surface mounting process, thereby creating the core employing the unit blocks made of soft magnetic metal powders.

The soft magnetic core may be produced as a single-phase reactor or a three-phase reactor as shown in FIGS. 2 and 3. Additionally, as shown in FIG. 3, it can be seen that the soft magnetic core, which was produced by attaching the unit blocks to each other, had better high current DC bias characteristics than a conventional laminated silicon steel type soft magnetic core.

### EXAMPLE 7

A block core was produced employing unit blocks, which were made of the powders of examples 1 to 5, through a procedure of example 6. Electromagnetic and noise characteristics of the block core are described in Table 1. From Table 1, it can be seen that inventive samples 1 to 7 have DC bias characteristics 2-14% higher and noise characteristics about 30 dB or more lower than comparative sample 1. Furthermore, they have DC bias characteristics that are higher than a typical toroidal core.

As described above, the core, which is produced employing the unit blocks made of the soft magnetic metal powders, has higher DC bias characteristics than a laminated silicon steel or a toroidal core at 250 Oe or more, at which the core is used in practice. Accordingly, it is believed that the core of the present invention can be used as a substitute for a soft magnetic core applied to an active filter (a high-current step-down inductor or a high-current step-up inductor) for PFC (power factor correction), a three-phase line reactor, or an inductor for automotive electronics employing a fuel cell system.

TABLE 1

| | | | | DC bias |
|---|---|---|---|---|
| | Composition | Noise | Core loss | characteristics |
| Samples | (wt %) | (db) | (mW/cm³) | (% u) |
| Comparative | Laminated silicon | 75 | 1300 | 40 |
| sample 1 | steel | | | |
| Comparative | Toroidal core | 45 | 300 | 40 |
| sample 2 | | | | |
| Inventive | S | 41 | 280 | 45 |
| sample 1 | | | | |
| Inventive | M | 38 | 250 | 50 |
| sample 2 | | | | |
| Inventive | H | 40 | 320 | 55 |
| sample 3 | | | | |
| Inventive | C | 45 | 620 | 53 |
| sample 4 | | | | |
| Inventive | C + S | 43 | 480 | 48 |
| sample 5 | | | | |
| Inventive | C + M | 40 | 460 | 51 |
| sample 6 | | | | |
| Inventive | C + H | 41 | 500 | 54 |
| sample 7 | | | | |

*M: MPP, H: High Flux, S: sendust, C: silicon steel powder

1. A unit block for a core employing soft magnetic metal powder, comprising:
one or more powders which each have an average particle size of 175 μm or less and which are selected from the group consisting of sendust powder, High Flux powder, MPP powder, and silicon steel powder,
wherein the powders are compacted and heat treated to form the unit block having a length of 3-10 cm, a width of 1-5 cm, and a height of 1-5 cm.

2. The unit block as set forth in claim 1, wherein the sendust powder contains 9-10% Si, 4-8% Al, and a balance of Fe, the High Flux powder contains 45-55% Ni and a balance of Fe, the MPP powder contains 80-81% Ni, 16-18% Fe, and 1.5-2.5% Mo, and the silicon steel powder contains 5-8 wt % Si and a balance of Fe.

3. A core, which employs unit blocks made of soft magnetic metal powders and which has excellent high-current DC bias characteristics, comprising:
the unit blocks for the core, which are produced using one or more selected from the group consisting of sendust powder, High Flux powder, MPP powder, and silicon steel powder, and which each have a length of 3-10 cm, a width of 1-5 cm, and a height of 1-5 cm,
wherein the unit blocks are attached to each other using a heat and fire resistant epoxy or polyurethane adhesive to form a single-phase reactor or a three-phase reactor.

4. A method of producing a core, which employs unit blocks made of soft magnetic metal powders and which has excellent high current DC bias characteristics, comprising:
mixing one or more, each having an average particle size of 175 μm or less, selected from the group consisting of sendust powder, High Flux powder, MPP powder, and silicon steel powder, with a solid lubricant;
compacting a powder mixture at a pressure of 10-18 tons per unit area so that each of the unit blocks is 3-10 cm long, 1-5 cm wide, and 1-5 cm high;
heat-treating the compacted mixture at 600-800° C. for 1-2 hours in an inert gas atmosphere to form the unit blocks each having a length of 3-10 cm, a width of 1-5 cm, and a height of 1-5 cm; and
attaching the unit blocks to each other using a heat and fire resistant epoxy or polyurethane adhesive to form the core.
